(19) United States
(12) Patent Application Publication
(10) Pub. No.: US 2010/0164861 A1
(43) Pub. Date: Jul. 1, 2010

(54) IMAGE SYSTEM CAPABLE OF SWITCHING PROGRAMS CORRESPONDING TO A PLURALITY OF FRAMES PROJECTED FROM A MULTIPLE VIEW DISPLAY AND METHOD THEREOF

(76) Inventors: Pay-Lun Ju, Taipei Hsien (TW); Pin-Hsien Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/434,669

(22) Filed: May 3, 2009

(30) Foreign Application Priority Data
Dec. 26, 2008 (TW) 097150999

(51) Int. Cl. G09G 5/00

(52) U.S. Cl. 345/156; 345/4

(57) ABSTRACT

An image system includes a multiple view display for displaying a plurality of frames simultaneously. The plurality of frames only can be viewed at different visible ranges respectively. The image system further includes a executing program means for inputting an executing program command, and a control means coupled to the executing program means for executing a program corresponding to a frame of the plurality of frames according to the executing program command transmitted from the executing program means.

### BACKGROUND OF THE INVENTION

1. Field of the Invention

The present invention relates to an image system and a method thereof, and more particularly, to an image system capable of switching programs corresponding to a plurality of frames projected from a multiple view display and a method thereof.

2. Description of the Prior Art

The technique for displaying a plurality of frames by a multiple view liquid crystal display (LCD) is published by Sharp Corp. in July, 2005. A user can view different frames at different visible angles on the same multiple view LCD according to the technique. For example, the user can view the different frames at a right side visible angle and at a left side visible angle respectively. Please refer to FIG. 1. FIG. 1 is a diagram of displaying two frames by a multiple view display 10 simultaneously in the prior art. A User A can view a frame C at the left side visible angle of the multiple view display 10, and a user B can view a frame D at the right side visible angle of the multiple view display 10. In regard to a principle of the multiple view display 10, different images displayed by the multiple view display 10 are transmitted at different directions, and the images viewed by the users are provided by beams of different view angles projected from light sources so that a single display can provide sorts of information. For example, if the multiple view display 10 is installed on a car, a driver can use an automotive navigating system on the multiple view display 10, and a passenger can use Internet on the multiple view display 10 at the same time, that is, all of the images are displayed by the same multiple view display 10 simultaneously. The multiple view display 10 can also be applied on an outdoor advertisement. For example, if the multiple view display 10 is installed at an intersection of roads, a walker or a driver coming from different ways can view different advertisements. However, the conventional multiple view LCD are restricted for outputting multiple view frames merely without other interactive operations as a drawback.

### SUMMARY OF THE INVENTION

According to the claimed invention, an image system includes a multiple view display for displaying a plurality of frames simultaneously wherein the plurality of frames only can be viewed at different visible ranges respectively, an executing program means for inputting an executing program command, and a control means coupled to the executing program means for executing a program corresponding to a frame of the plurality of frames according to the executing program command transmitted from the executing program means.

According to the claimed invention, the executing program means is a human-computer interface executing program means.

According to the claimed invention, the executing program means is a mouse, a keyboard, a touch device, or a button.

According to the claimed invention, the executing program means is a sensor for generating the executing program command according to a sensing result.

According to the claimed invention, the sensor is an acceleration sensor (G sensor) or an orientation sensor.

According to the claimed invention, the orientation sensor is a gyroscope, an accelerometer, or a ball switch.

According to the claimed invention, the control means is used for setting a status index according to the executing program command transmitted from the executing program means so as to assign an access request for executing the program corresponding to the frame of the plurality of frames.

According to the claimed invention, the control means is used for prompting executing the program corresponding to the frame of the plurality of frames after receiving the executing program command transmitted from the executing program means.

According to the claimed invention, the control means is used for prompting inputting commands into the program corresponding to the frame of the plurality of frames after receiving the executing program command transmitted from the executing program means.

According to the claimed invention, the image system is a mobile phone, a mobile internet device, a personal navigating device, a digital photo frame, or a notebook computer.

According to the claimed invention, a method for controlling an image system is disclosed. The method includes displaying a plurality of frames by a multiple view display of the image system simultaneously wherein the plurality of frames only can be viewed at different visible ranges respectively, inputting an executing program command, and executing a program corresponding to a frame of the plurality of frames according to the executing program command.

According to the claimed invention, inputting the executing program command includes utilizing a human-computer interface executing program means to input the executing program command.

According to the claimed invention, inputting the executing program command includes sensing a status of the image system and inputting the executing program command according to the sensed status of the image system.

According to the claimed invention, inputting the executing program command includes sensing an inclined status of the image system and inputting the executing program command according to the inclined status of the image system.

According to the claimed invention, executing the program corresponding to the frame of the plurality of frames according to the executing program command includes setting a status index according to the executing program command so as to execute the program corresponding to the frame of the plurality of frames.

According to the claimed invention, the method further includes prompting executing the program corresponding to the frame of the plurality of frames according to the executing program command.

According to the claimed invention, the method further includes prompting inputting commands into the program corresponding to the frame of the plurality of frames according to the executing program command.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of displaying two frames by a multiple view display simultaneously in the prior art.

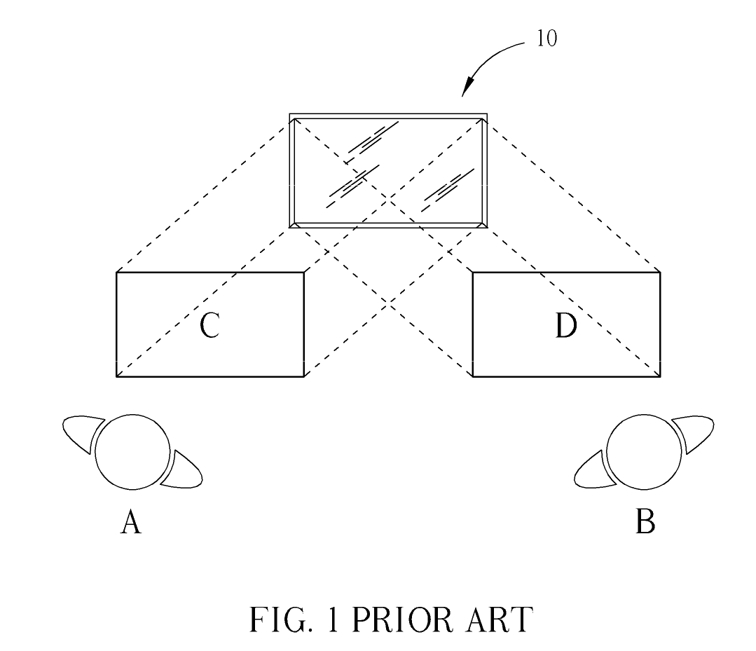

FIG. 2 is a diagram of an image system displaying two frames according to a preferred embodiment of the present invention.

FIG. 3 is a functional block diagram of the image system according to the preferred embodiment of the present invention.

FIG. 4 is a flowchart of switching inputs of programs corresponding to the two frames displayed simultaneously by the multiple view display of the image system according to the preferred embodiment of the present invention.

### DETAILED DESCRIPTION

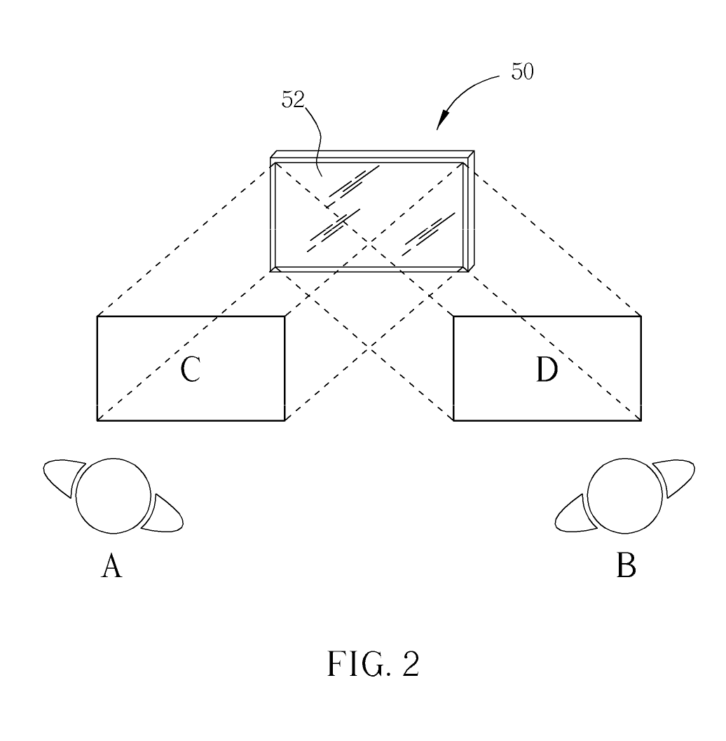

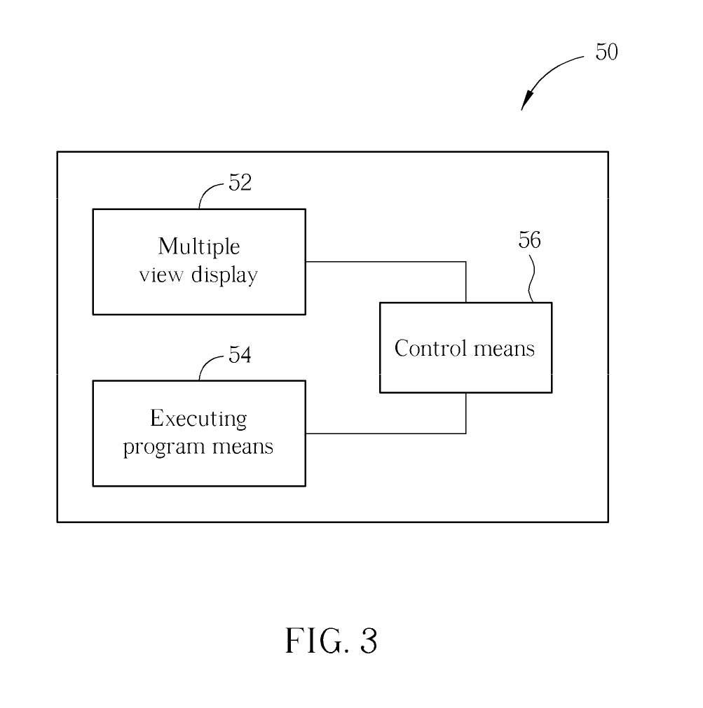

Please refer to FIG. 2 and FIG. 3. FIG. 2 is a diagram of an image system 50 displaying two frames according to a preferred embodiment of the present invention. FIG. 3 is a functional block diagram of the image system 50 according to the preferred embodiment of the present invention. The image system 50 can be a mobile phone, a mobile internet device, a personal navigating device, a digital photo frame, or a notebook computer. The image system 50 includes a multiple view display 52 for displaying a plurality of frames simultaneously. The plurality of frames only can be viewed at different visible ranges respectively. The multiple view display 52 can be a multiple view liquid crystal display. In this embodiment, the multiple view display 52 can display two frames simultaneously. A User A can view a frame C at a left side visible angle of the multiple view display 52, and a user B can view a frame D at a right side visible angle of the multiple view display 52. In regard to a principle of the multiple view display 52, images displayed by the multiple view display 52 are transmitted at different directions, the images viewed by a user are provided by beams of different view angles projected from light sources, and the single display can provide sorts of information. The multiple view display 52 of the image system 50 of the present invention can be designed for displaying the plurality of frames, such as more than two frames.

The image system 50 further includes an executing program means 54 for inputting an executing program command. The executing program means 54 can be configured as hardware, firmware, or software. For example, the executing program means 54 can be a human-computer interface executing program means, such as a mouse, a keyboard, a touch device, a button, and so on. The user can input the executing program command by operating the hardware. The executing program means 54 can also be a switching program. The user can input the executing program command by operating the software, such as operating application programs. The executing program means 54 can also be a sensor for generating the executing program command according to a sensing result. For example, the executing program means 54 can be an acceleration sensor (G sensor) or an orientation sensor, such as a gyroscope, an accelerometer, or a ball switch. For example, the executing program means 54 can sense an inclined status of the image system 50 and then input the executing program command according to the sensed inclined status. If the image system 50 is inclined to a left side, the executing program command corresponding to a left frame is inputted. If the image system 50 is inclined to a right side, the executing program command corresponding to a right frame is inputted. The image system 50 further includes a control means 56 coupled to the multiple view display 52 and executing program means 54. The control means 56 is used for assigning an access request for executing a program corresponding to the frame C and the frame D alternatively according to the executing program command transmitted from the executing program means 54. For example, the control means 56 can set a status index according to the executing program command transmitted from the executing program means 54 so as to assign the access request for executing the program corresponding to the frame of the plurality of frames.

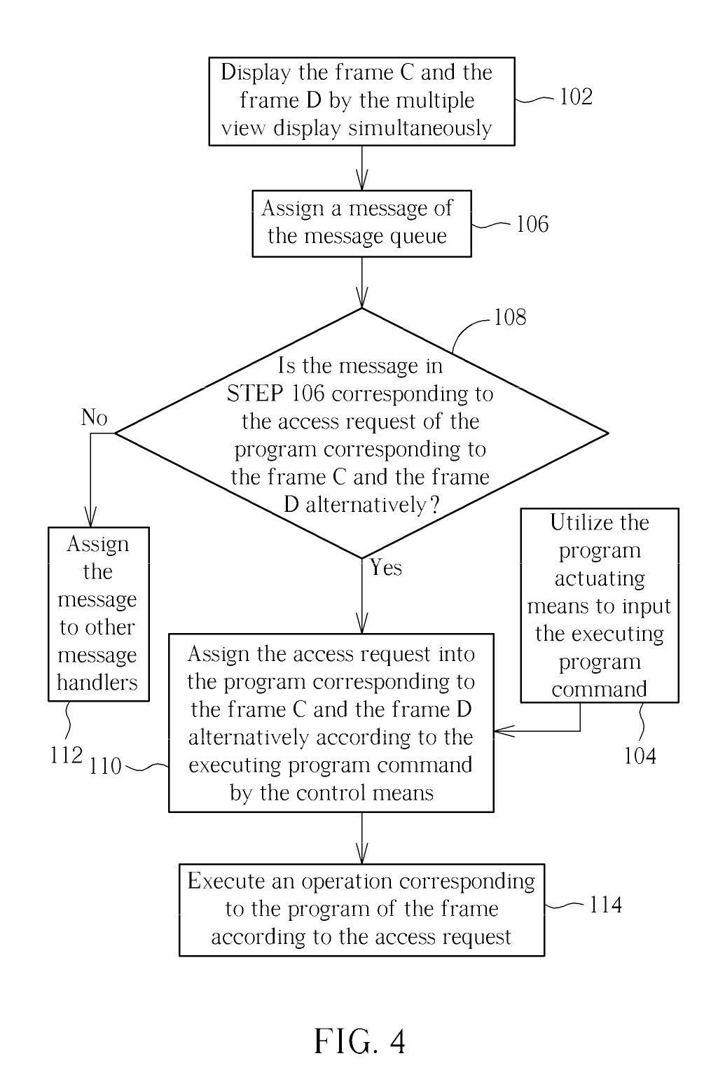

Please refer to FIG. 4. FIG. 4 is a flowchart of switching inputs of programs corresponding to the two frames displayed by the multiple view display 52 of the image system 50 simultaneously according to the preferred embodiment of the present invention. FIG. 4 includes following steps:

STEP 102: Display the frame C and the frame D by the multiple view display 52 simultaneously wherein the frame C and the frame D only can be viewed at different visible ranges respectively.

STEP 104: Utilize the executing program means 54 to input the executing program command.

STEP 106: Assign a message of a message queue.

STEP 108: Determine whether the message in STEP 106 is corresponding to the access request of the program corresponding to the frame C and the frame D alternatively. If yes, go to STEP 110, else go to STEP 112.

STEP 110: Assign the access request into the program corresponding to the frame C and the frame D alternatively according to the executing program command by the control means 56.

STEP 112: Assign the message to other message handlers.

STEP 114: Execute an operation corresponding to the program of the frame according to the access request.

First, the multiple view display 52 of the image system 50 can display the frame C and the frame D simultaneously according to the above-mentioned principle. The frame C and the frame D only can be viewed at different visible ranges respectively so that the single multiple view display 52 can provide two sorts of information. For example, the multiple view display 52 can display a navigating frame and a television frame simultaneously. After that, if the user demands to select the program corresponding to the frame C and the frame D alternatively, the user can utilize the executing program means 54 to input the executing program command by different ways according to different forms of the executing program means 54. For example, the executing program means 54 can be the human-computer interface executing program means, such as the mouse, the keyboard, the touch device, the button, and so on. The user can input the executing program command by operating the hardware, such as pressing the corresponding button for selecting a demanding frame. The executing program means 54 can be the switching program. The user can input the executing program command by operating the software, such as operating the application programs. The executing program means 54 can be the sensor for generating the executing program command according to the sensing result. For example, the executing program means 54 can sense the inclined status of the image system 50 and input the executing program command according to the sensed inclined status. If the image system 50 is inclined to the left side, the executing program command corresponding to the left frame is inputted. If the image system 50 is inclined to the right side, the executing program command corresponding to the right frame is inputted.

At the same time, the image system 50 assigns the message of the message queue. If a judged message is not the access request corresponding to the program of the frame C and the frame D alternatively, it means that the message is irrelevant to the frame C and the frame D, and the message is assigned to the other message handlers for processing. If the judged message is the access request corresponding to the program of the frame C and the frame D alternatively, it means that the message is related to the frame C and the frame D alternatively, and the control means 56 can assign the access request into the program corresponding to the frame C and the frame D alternatively according to the executing program command. For example, the control means 56 can set the status index according to the executing program command transmitted from the executing program means 54 so as to assign the access request into the program corresponding to the frame C and the frame D alternatively. That is to say, an operating frame can be selected as the frame C or the frame D according to the executing program command. Then, the access request is assigned into the program corresponding to the frame C or the frame D which being selected. After that, the program corresponding to the selected frame can be operated according to the access request correspondingly. For example, if the navigating frame is selected, following commands can be inputted into a navigating program corresponding to the navigating frame, such as inputting a place name or selecting a region from a map. If the television frame is selected, following commands can be inputted into a playing program corresponding to the television frame, such as adjusting volume or selecting a channel.

In addition, after the control means 56 receives the executing program command, the control means 56 can prompt executing a switched program corresponding to the frame C and the frame D alternatively at present. For example, if the frame C is switched presently, an executing prompt can be shown on the frame C and a stopping prompt can be shown on the frame D simultaneously so as to prompt the user that the current operating frame is the frame C, not the frame D. Furthermore, after the control means 56 receives the executing program command, the control means 56 can also prompt inputting the commands into the switched program of the selected frame. For example, if the frame C is switched presently, a message for reminding the user to input following commands for the program corresponding to the frame C can be prompted on the frame C.

In the above-mentioned embodiment, the multiple view display 52 of the image system 50 is designed for displaying the two frames simultaneously. The multiple view display 52 of the image system 50 of the present invention can also designed for displaying the plurality of frames, such as more than two frames. A working principle of switching programs corresponding to different frames is the same as the one according to the above-mentioned embodiment, it means that the operating frame can be selected from the plurality of frames according to the executing program command, and detailed description is omitted herein for simplicity.

In contrast to the prior art, the present invention provide an image system capable of switching programs corresponding to the plurality of frames displayed by the multiple view display simultaneously and a method thereof. The user can switch inputs and operation between the programs corresponding to different frames conveniently. Besides outputting the multiple view frames, the present invention further provides interactive operations of switching window frames and inputting operating commands and also improves applications of the multiple view LCD.

Those skilled in the art will readily observe that numerous modifications and alterations of the device and method may be made while retaining the teachings of the invention.

What is claimed is:

1. An image system comprising:
a multiple view display for displaying a plurality of frames simultaneously wherein the plurality of frames only can be viewed at different visible ranges respectively;
an executing program means for inputting an executing program command; and
a control means coupled to the executing program means for executing a program corresponding to a frame of the plurality of frames according to the executing program command transmitted from the executing program means.

2. The image system of claim 1, wherein the executing program means is a human-computer interface executing program means.

3. The image system of claim 2, wherein the executing program means is one of a mouse, keyboard, touch device and a button.

4. The image system of claim 1, wherein the executing program means is a sensor for generating the executing program command according to a sensing result.

5. The image system of claim 4, wherein the sensor is one of an acceleration sensor (G sensor) and an orientation sensor.

6. The image system of claim 5, wherein the orientation sensor is one of a gyroscope and an accelerometer.

7. The image system of claim 4, wherein the sensor is a ball switch.

8. The image system of claim 1, wherein the control means is used for setting a status index according to the executing program command transmitted from the executing program means so as to assign an access request for executing the program corresponding to the frame of the plurality of frames.

9. The image system of claim 1, wherein the control means is used for prompting executing the program corresponding to the frame of the plurality of frames after receiving the executing program command transmitted from the executing program means.

10. The image system of claim 1, wherein the control means is used for prompting inputting commands into the program corresponding to the frame of the plurality of frames after receiving the executing program command transmitted from the executing program means.

11. The image system of claim 1, wherein the image system is one of a mobile phone, mobile internet device, personal navigating device, digital photo frame and a notebook computer.

12. A method for controlling an image system, the method comprising:
displaying a plurality of frames by a multiple view display of the image system simultaneously wherein the plurality of frames only can be viewed at different visible ranges respectively;
inputting an executing program command; and
executing a program corresponding to a frame of the plurality of frames according to the executing program command.

13. The method of claim 12, wherein inputting the executing program command comprises utilizing a human-computer interface executing program means to input the executing program command.

14. The method of claim 12, wherein inputting the executing program command comprises sensing a status of the image system and inputting the executing program command according to the sensed status of the image system.

15. The method of claim 14, wherein inputting the executing program command comprises sensing an inclined status of the image system and inputting the executing program command according to the inclined status of the image system.

16. The method of claim 12, wherein executing the program corresponding to the frame of the plurality of frames according to the executing program command comprises setting a status index according to the executing program command so as to execute the program corresponding to the frame of the plurality of frames.

17. The method of claim 12, the method further comprising:
prompting executing the program corresponding to the frame of the plurality of frames according to the executing program command.

18. The method of claim 12, the method further comprising:
prompting inputting commands into the program corresponding to the frame of the plurality of frames according to the executing program command.
